(19) United States
(12) Patent Application Publication
(10) Pub. No.: US 2006/0272846 A1
(43) Pub. Date: Dec. 7, 2006

(54) Support Means with Mechanically Positive Connection for Connecting Several Cables

(75) Inventor: Karl Weinberger, Immensee (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(73) Assignee: INVENTIO AG, Hergiswil NW (CH)

(21) Appl. No.: 11/421,198

(22) Filed: May 31, 2006

(30) Foreign Application Priority Data
Jun. 2, 2005 (EP) 05104787.6

(51) Int. Cl. H01B 11/02

(52) U.S. Cl. 174/115

(57) ABSTRACT

A support for an elevator installation includes at least two cables of several strands each, which are designed for acceptance of force in longitudinal direction, and wherein the cables are arranged along the longitudinal direction at a spacing from one another and are connected by a cable casing, which forms a web between the two cables. Connectors are provided in the region of the web, wherein the connectors are so designed that they enable a guided relative movement of the cables relative to one another in the longitudinal direction.

### BACKGROUND OF THE INVENTION

The present invention relates to a support means for use in an elevator installation with several cables extending at a spacing from one another and a cable casing.

Running cables are an important, highly loaded machine element in conveying technology, particularly in the case of elevators, in crane construction and in mining. The loading of driven cables, as used in, for example, elevator construction, is particularly multi-faceted.

In the case of conventional elevator installations, the elevator car and the counterweight are connected together by way of several steel strand cables. The cables run over a drive pulley driven by a drive motor. The drive moment is imposed under friction couple on the respective cable section lying on the drive pulley over the looping angle. In that case the cable experiences tension, bending, compression and torsional stresses. The relative motions arising due to the bending over the cable pulley cause friction within the cable structure, which can have a negative effect on cable wear. Depending on a respective cable construction, bending radius, groove profile and cable safety factor the primary and secondary stresses which arise have a negative influence on the cable state.

Apart from strength requirements, there is the further requirement in the case of elevator installations for, for reasons of energy, smallest possible masses. High-strength synthetic fiber cables, for example of aromatic polyamides, especially aramides, fulfill these demands better than steel cables.

Cables made of aramide fibers have, for the same cross-section and same load-bearing capability by comparison with conventional steel cables, only a quarter to a fifth of the specific cable weight. By contrast to steel, however, aramide fiber has a substantially lower transverse strength in relation to longitudinal load-bearing capability.

Consequently, in order to expose the aramide fibers to the smallest possible transverse stresses when running over the drive pulley a parallelly stranded aramide fiber strand cable suitable as a drive cable is shown in, for example, European Patent Application EP 0 672 781 A1. The aramide cable known therefrom offers very satisfactory values with respect to service life, high abrasion strength and ultimate bending strength; however, in unfavorable circumstances the possibility exists with parallelly stranded aramide cables that partial cable unravelling phenomena occur which permanently disturb the original cable structure in its balance.

These twisting phenomena and the changes in cable structure can be avoided with, for example, a synthetic fiber cable according to European Patent Application EP 1 061 172 A2. For this purpose the synthetic fiber cable comprises two parallelly extending cables which are connected together by way of a cable casing. The synthetic fiber cable according to EP 1 061 172 A2 achieves a longitudinal strength substantially through the characteristics of the two cables extending in parallel. The cable casing, thereagainst, prevents twisting phenomena and changes in the cable structure. Moreover, the cable casing serves as insulation (protective effect) and it has a high coefficient of friction. A weak point can be, according to the respective field of application and use, the web of such a synthetic fiber cable according to EP 1 061 172 A2.

Support means for two or more cables have disadvantages if they are so moved during running around a drive pulley that the individual cables run on tracks with different radius. Due to the radius differences the cables are moved by the traction of the drive pulley at different speed. The web part of the cable casing is thereby exposed to a shearing stress. Due to the shearing action the web region of the cable casing can be damaged, particularly when shearing forces occurring dynamically are concerned.

### SUMMARY OF THE INVENTION

The present invention has an object of further improving the known support means, which comprise two or more cables, in order inter alia to avoid web fracture. This applies particularly to support means comprising synthetic fiber cables.

The present invention is based on recognition that the stated problems do not gain the upper hand if the web region is stiffened. Thus, the direct effects of the shearing forces can indeed be prevented, but in this case the more rapidly circulating cable drags along the other cable and slip occurs which causes increased abrasion.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1A is a schematic sectional view of a first support means according to the present invention with two cables;

FIG. 1B is a perspective view of the support means according to FIG. 1A;

FIG. 2A is a schematic sectional view of a second support means according to the present invention with three cables; and

FIG. 2B is a perspective illustration of the support means according to FIG. 2A.

### DESCRIPTION OF THE PREFERRED EMBODIMENT

Constructional elements which are the same or have the same effect are provided in all figures with the same reference numerals even if they are not of identical construction in details. The figures are not to scale.

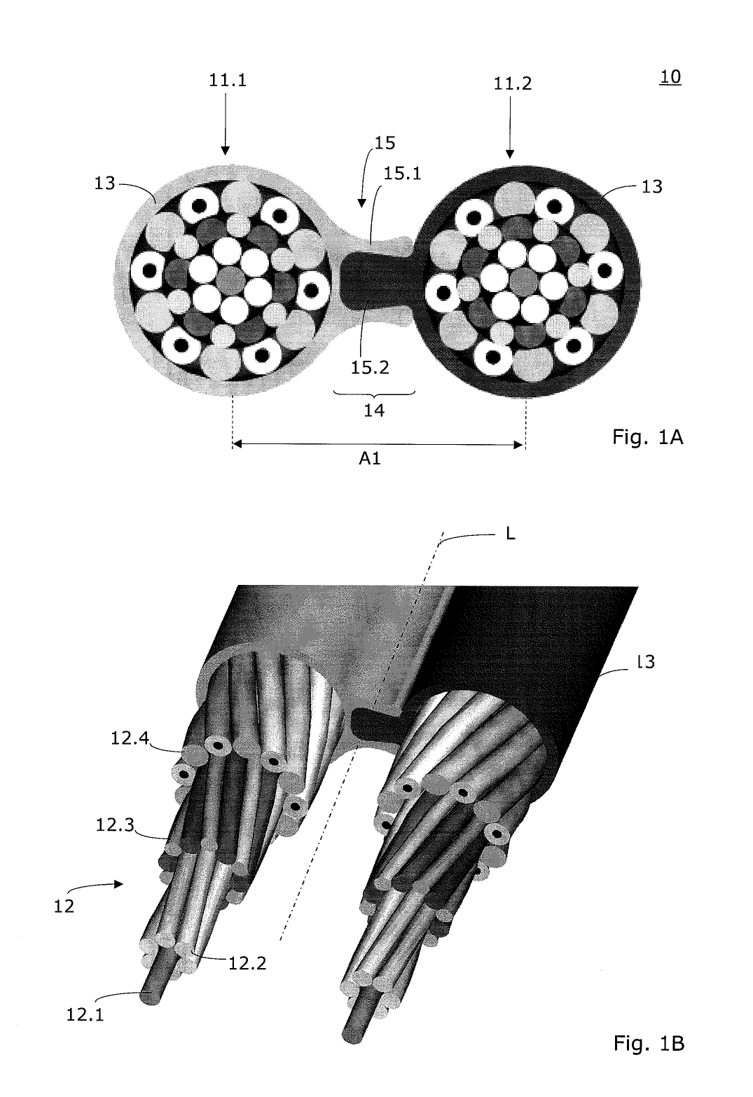

A first support means 10 for use in an elevator installation is shown in FIG. 1A and FIG. 1B. The support means 10 comprises at least two cables 11.1 and 11.2. These cables 11.1 and 11.2 comprise, for example, synthetic fiber strands 12 designed for acceptance of force in a longitudinal direction L. The cables 11.1 and 11.2 are arranged parallel to one another along the longitudinal direction L of the support means 10 at a spacing A1 (center-to-center). The cables 11.1, 11.2 are fixed relative to one another to be secure against twisting by a cable casing 13 with a web region 14. The cable casing 13 forms a transition region, which extends parallel to the longitudinal direction L of the support means 10, between the two cables, which region is termed a web or the web region 14.

According to the present invention, connecting means 15 are provided in the region of the web 14. These connecting means 15 are designed so that they enable a guided relative motion of the cable 11.1, 11.2 in the longitudinal direction L. It can be seen from FIGS. 1A and 1B how these connecting means 15 are designed in the case of the first form of embodiment. The cable casing 13 of the first cable 11.1 has a form of longitudinal groove 15.1 extending parallel to the longitudinal direction L of the support means 10. Provided at the cable casing 13 of the second cable 11.2 is a corresponding counter-member 15.2 that engages in the longitudinal groove 15.1. Such a connection can be termed, for example, a key-end-groove connection, wherein the counter-member 15.2 serves as key and the longitudinal groove 15.1 as the groove.

In FIG. 1B it can be seen in the perspective illustration how the cable casings 13 of the two cables 11.1, 11.2 are connected together by the connecting means 15. In that case the connecting means 15 are designed so that a relative displacement parallel to the longitudinal direction L of the two cables 11.1, 11.2 is possible.

According to the present invention at least two cables are thus connected together, but not by a rigid connection. The connection between the adjacent cables 11.1, 11.2 of the support means 10 according to the present invention is created by way of the connecting elements 15.1, 15.2 which are each connected with a respective adjacent one of the cables and can be joined together in a mechanically positive manner and which on the one hand make possible transmission of torsional moments from one cable 11.1 to the adjacent cable 11.2, but on the other hand enable displacement of the cables 11.1, 11.2 relative to one another in the longitudinal direction L of the support means 10.

It is important that the connecting means 15 comprise the guide element 15.1 and the corresponding counter-member 15.2 making possible a guided relative motion of the cables 11.1, 11.2 relative to one another in longitudinal direction (L).

The connecting means 15 are preferably designed so that no deformation of the connecting elements 15 due to shearing movement in the longitudinal direction L happens. This can be achieved in that the friction between the mutually contacting connecting elements 15.1, 15.2 is so small that they can slide past one another at least at certain length sections.

The term “relative displacement of the adjacent cables” includes, according to the invention, two cases:

(1) the two cables 11.1, 11.2 can be uniformly displaced relative to one another over their entire length (with the same stretching of the cables),

(2) one of the cables 11.1 and 11.2 can be stretched more strongly than the other, wherein during the stretching relative displacements between individual length sections of the respective cables arise (the amount of the relative displacement in that case depends on the length position on the cable).

According to the present invention the connection between the adjacent cables 11.1, 11.2 is thus not loaded or even deformed by a shear stress.

The described principle can also be transferred to an ensemble of three or more cables.

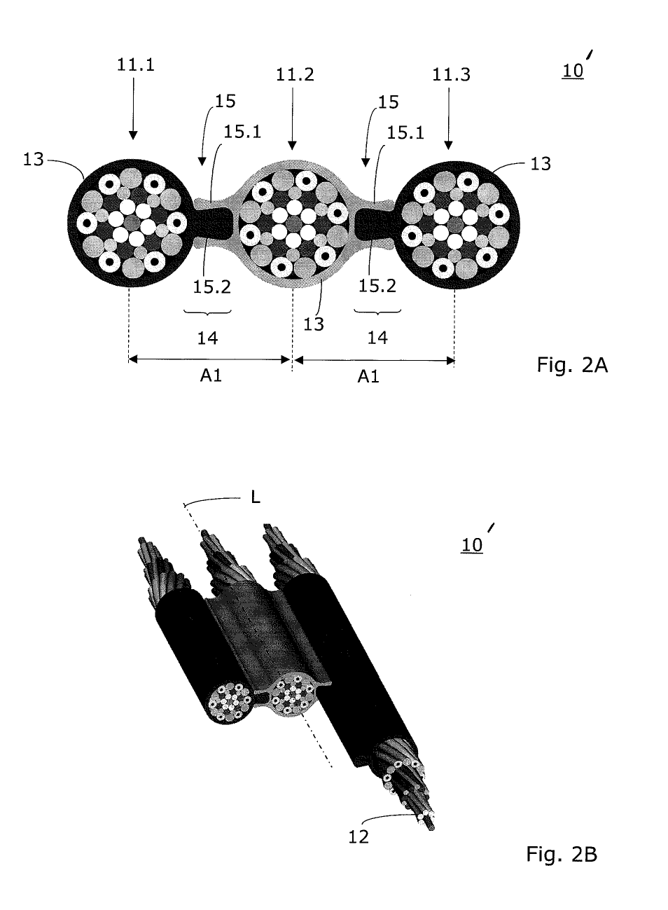

A support means 10′ according to the present invention with three cables 11.1 to 11.3 is shown in FIGS. 2A and 2B. The support means 10′ is, as also the support means 10 shown in FIGS. 1A, 1B, designed for use in an elevator installation. The support means 10′ comprises the three cables 11.1, 11.2, 11.3, wherein each of the three cables 11.1, 11.2, 11.3 comprises several of the strands 12. The cables 11.1, 11.2, 11.3 are designed for acceptance of force in the longitudinal direction L, wherein the cables 11.1, 11.2, 11.3 are arranged along the longitudinal direction L of the support means 10′ at the spacing A1 from one another and are connected by means of the cable casing 13. The cable casing 13 forms the web region 14 between each two adjacent ones of the cables 11.1, 11.2 and 11.2, 11.3. The connecting means 15 are again provided in the region of the web 14. The connecting means 15 are designed so that they enable a guided relative movement of the cable 11.1 with respect to the cable 11.2 and of the cable 11.2 with respect to the cable 11.3, in the longitudinal direction L.

It can be seen by way of FIGS. 2A and 2B that the two outer cables 11.1 and 11.3 each have the counter-member 15.2 facing towards the inner cable 11.2. These counter-members 15.2 extend parallel to the longitudinal axis L. They are designed so that they engage in the longitudinal grooves 15.1 of the middle cable 11.2 and enable the mentioned relative displacement of the cables with respect to one another.

In preferred forms of embodiment of the invention the strands 12 of the cables are laid so that at least two of the cables of the support means 10 build up, under torsional stress, (mutually compensating) inherent torsional moments of opposite sense.

In the example shown in FIG. 1B the strands 12 of each of these cables are respectively laid parallelly (with the same rotational sense), whilst the strands of different cables 11.1 and 11.2 are laid with opposite sense of rotation.

The connecting elements 15.1, 15.2 can be a component of the casing 13 of the respective cable 11.1 to 11.3. They can in this case be secured to the casing 13 of the respective cable in a single production step (by extrusion or vulcanization according to the respective material).

Advantageously, each cable 11.1 to 11.3 can be individually produced in each instance by the same tool.

Subsequently, several cables can be combined in that respectively complementary connecting elements 15.1, 15.2 are plugged into one another. Instead of connecting the connecting elements together by plugging, the connecting elements can also be designed so that the counter-member 15.2 is pushed into the longitudinal groove 15.1 along the longitudinal axis L.

An optimization parameter is the coefficient of friction between the complementary connecting elements 15.1, 15.2. Through optimization of the coefficient of friction the shear stresses in the connecting elements 15 in the case of relative movements of the cables are avoided or at least minimized.

Moreover, it is possible to equip the individual connecting elements 15 with a mechanical reinforcement.

The use of support means 10, 10′ with synthetic fiber cables is particularly preferred. Metallic, synthetic and/or organic strands 12, or a combination of the said materials, are particularly preferred.

The cables 11.1 to 11.3 are preferably produced by two-stage or multi-stage twisting of the strands 12. The cables 11.1 to 11.3 comprising three layers 12.2, 12.3, 12.4 with strands and a central strand 12.1 are shown in FIGS. 1A to 2B. However, this is only an example for the construction of the cables 11.1 to 11.3.

Cable yarns of aramide fibers, for example, can be twisted together in the cables 11.1 to 11.3.

As can be seen in the figures, the entire outer circumference of the cables 11.1 to 11.3 is enclosed by the cable casing 13 of synthetic material. The cable casing 13 can comprise synthetic and/or organic materials. The following materials are particularly suitable as cable casings: rubber, polyurethane, polyolefin, polyvinylchloride or polyamide. The respectively resiliently deformable synthetic material is preferably injection-molded or extruded onto the cables 11.1 to 11.3 and subsequently compacted thereon. The cable casing material thereby penetrates from outside into all interstices between the strands 12 at the outer circumference and fills up these. The thus-created coupling of the cable casing 13 to the strand 12 is so strong that only small relative movements arise between the strands 12 of the cables 11.1 and 11.3 and the cable casing 13. Either the longitudinal groove 15.1 or the counter-member 15.2 is fastened to the cable casing or integrated in the cable casing 13, the counter-member being designed so that it can be plugged into or pushed into the longitudinal groove 15.1.

The connecting elements 15 are preferably intimately connected with the cable casing 13, as shown in the figures.

Preferably, the connecting elements 15 are of elongate construction and extend in the longitudinal direction L along the cable casing 13. However, it is also conceivable for the connecting elements 15 to extend in each instance only over length sections of the support means 10, 10′. Length sections in which no web 14 is present between adjacent cables are then preferably disposed between these length sections.

According to a further form of embodiment short fiber pieces (for example glass fibers, aramide fibers or the like) or a woven mat can be embedded in the region of the connecting elements 15 and serves or serve as reinforcement.

The support means 10, 10′ shown in the figures are particularly suitable for drive by a cable pulley, wherein the force transmission between the cable pulley and the support means 10, 10′ takes place substantially by friction couple.

The forms of embodiment according to the present invention make it possible to avoid web fractures or weakenings in the web region, in that shearing movements are converted into longitudinal displacements parallel to the longitudinal axis L. Damage of the web region and at the same time abrasion of conventional support means with two or more cables can thereby be reduced.

The double, triple or multiple cable according to the present invention can without problems provide compensation for running radius differences at drive pulleys when the cables of the support means 10, 10′ move at a drive pulley along circular paths of different radius and accordingly at different speed at the circumference of the drive pulley.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A support means for an elevator installation comprising:
at least two cables of several strands each, which cables are designed for acceptance of force in a longitudinal direction, wherein said at least two cables are arranged along a longitudinal direction of the support means at a spacing from one another;
a cable casing connecting said at least two cables, which casing forms a web between said at least two cables; and
a connecting means positioned at the web, said connecting means permitting guided relative movement of said at least two cables with respect to one another in the longitudinal direction.

2. The support means according to claim 1 wherein said connecting means includes a guide element enabling the guided relative movement of said at least two cables with respect to one another in the longitudinal direction.

3. The support means according to claim 1 wherein said strands of said at least two cables are loaded by inherent torsional moments of opposite sense so as to avoid twisting of the support means along the longitudinal axis.

4. The support means according to claim 1 wherein said cable casing is formed of synthetic and/or organic materials.

5. The support means according to claim 1 wherein said strands are formed of at least one of metallic, synthetic and organic materials.

6. The support means according to claim 1 wherein said connecting means is a mechanically positive key-and-groove connection.

7. The support means according to claim 1 wherein said connecting means includes a longitudinal groove extending adjacent one of said at least two cables in the longitudinal direction and a counter-member extending adjacent another one of said at least two cables and which engages in said longitudinal groove.

8. The support means according to claim 1 wherein said connecting means are formed as a pair of pluggable connecting elements.

9. The support means according to claim 1 wherein said connecting means are formed as an integral component of said cable casing.

10. A support means for an elevator installation comprising:
at least three cables of several strands each, which cables are designed for acceptance of force in a longitudinal direction, wherein said at least three cables are arranged along a longitudinal direction of the support means at a spacing from one another;
a cable casing connecting said at least three cables, which casing forms a web between a center cable of said at least three cables and a pair of side cables of said at least three cable on opposite sides of said center cable; and
a connecting means positioned at the web, said connecting means permitting guided relative movement of said at least three cables with respect to one another in the longitudinal direction.

11. The support means according to claim 10 wherein said connecting means includes a pair of opposed longitudinal grooves formed in said web adjacent said center cable and a pair of counter-members, each said counter-member extending adjacent an associated one of said side cables and slidably engaging one of said grooves.
